(19) United States
(12) Patent Application Publication
(10) Pub. No.: US 2008/0098929 A1
(43) Pub. Date: May 1, 2008

(54) PHASE CHANGE INKS

(75) Inventors: Caroline M. Turek, Hamilton (CA); Raymond W. Wong, Mississauga (CA); Adela Goredema, Mississauga (CA); Christopher A. Wagner, Etobicoke (CA)

Correspondence Address: OLIFF & BERRIDGE, PLC., P.O. BOX 320850, ALEXANDRIA, VA, 22320-4850, US

(73) Assignee: Xerox Corporation, Stamford, CT (US)

(21) Appl. No.: 11/553,260

(22) Filed: Oct. 26, 2006

(51) Int. Cl. C09D 11/00; C09D 11/02

(52) U.S. Cl. 106/31.29; 106/31.61; 106/31.43; 106/31.75; 106/31.3; 106/31.62

(57) ABSTRACT

A phase change ink having an ink vehicle, at least one colorant at least one triamide and at least one bis-urethane. The at least one triamide and at least one bis-urethane assist in dispersing colorants, such as pigments like carbon black, in non-polar ink vehicles. Also, disclosed are methods of making such phase change inks.

### BACKGROUND

Described herein are inks such as phase change or hot melt inks that have a colorant, such as a pigment, substantially evenly dispersed throughout the non-polar ink vehicle.

The phase change ink compositions illustrated herein in embodiments are solid at room temperature, for example from about 20° C. to about 27° C., and are suitable for ink jet printing processes, particularly piezoelectric and acoustic ink jet printing processes.

In embodiments, the phase change ink comprises an ink vehicle, a colorant and at least one dispersant comprising at least one triamide, and at least one bis-urethane. Also, disclosed are methods of making such phase change inks.

### REFERENCES

Ink jetting devices are known in the art. As described in U.S. Pat. No. 6,547,380, the disclosure of which is totally incorporated herein by reference, ink jet printing systems are generally of two types: continuous stream and drop-on-demand. In continuous stream ink jet systems, ink is emitted in a continuous stream under pressure through at least one orifice or nozzle. The stream is perturbed, causing it to break up into droplets at a fixed distance from the orifice. At the break-up point, the droplets are charged in accordance with digital data signals and passed through an electrostatic field that adjusts the trajectory of each droplet in order to direct it to a gutter for recirculation or a specific location on a recording medium. In drop-on-demand systems, a droplet is expelled from an orifice directly to a position on a recording medium in accordance with digital data signals. A droplet is not formed or expelled unless it is to be placed on the recording medium. There are generally three types of drop-on-demand ink jet systems. One type of drop-on-demand system is a piezoelectric device that has as its major components an ink filled channel or passageway having a nozzle on one end and a piezoelectric transducer near the other end to produce pressure pulses. Another type of drop-on-demand system is known as acoustic ink printing. As is known, an acoustic beam exerts a radiation pressure against objects upon which it impinges. Thus, when an acoustic beam impinges on a free surface (i.e., liquid/air interface) of a pool of liquid from beneath, the radiation pressure which it exerts against the surface of the pool may reach a sufficiently high level to release individual droplets of liquid from the pool, despite the restraining force of surface tension. Focusing the beam on or near the surface of the pool intensifies the radiation pressure it exerts for a given amount of input power. Still another type of drop-on-demand system is known as thermal ink jet, or bubble jet, and produces high velocity droplets. The major components of this type of drop-on-demand system are an ink filled channel having a nozzle on one end and a heat generating resistor near the nozzle. Printing signals representing digital information originate an electric current pulse in a resistive layer within each ink passageway near the orifice or nozzle, causing the ink vehicle (usually water) in the immediate vicinity to vaporize almost instantaneously and create a bubble. The ink at the orifice is forced out as a propelled droplet as the bubble expands.

In a typical design of a piezoelectric ink jet device, the image is applied by jetting appropriately colored inks during four to eighteen rotations (incremental movements) of a substrate such as an image receiving member or intermediate transfer member with respect to the ink jetting head, i.e., there is a small translation of the printhead with respect to the substrate in between each rotation. This approach simplifies the printhead design, and the small movements ensure good droplet registration. At the jet operating temperature, droplets of liquid ink are ejected from the printing device. When the ink droplets contact the surface of the recording substrate, either directly or via an intermediate heated transfer belt or drum, they quickly solidify to form a predetermined pattern of solidified ink drops. Phase change ink jet processes are well known and are described, for example, in U.S. Pat. Nos. 4,601,777, 4,251,824, 4,410,899, 4,412,224 and 4,532,530, the disclosures of each of which are totally incorporated herein by reference.

Ink jet printing processes may employ inks that are solid at room temperature and liquid at elevated temperatures. Such inks may be referred to as hot melt inks or phase change inks. For example, U.S. Pat. No. 4,490,731, the disclosure of which is totally incorporated herein by reference, discloses an apparatus for dispensing solid ink for printing on a substrate such as paper.

In thermal ink jet printing processes employing hot melt inks, the solid ink is melted by the heater in the printing apparatus and utilized (i.e., jetted) as a liquid in a manner similar to that of conventional thermal ink jet printing. Upon contact with the printing substrate, the molten ink solidifies rapidly, enabling the colorant to substantially remain on the surface of the substrate instead of being carried into the substrate (for example, paper) by capillary action, thereby enabling higher print density than is generally obtained with liquid inks. Advantages of a phase change ink in ink jet printing thus include elimination of potential spillage of the ink during handling, a wide range of print density and quality, minimal paper cockle or distortion, and enablement of indefinite periods of nonprinting without the danger of nozzle clogging, even without capping the nozzles.

U.S. Pat. Nos. 5,006,170 and 5,122,187, the disclosures of each of which are totally incorporated herein by reference, disclose hot melt ink compositions suitable for ink jet printing which comprise a colorant, a binder, and a propellant.

U.S. Pat. No. 4,889,560, the disclosure of which is totally incorporated herein by reference, discloses a phase change ink carrier composition combined with a colorant to form a phase change ink composition.

EP0816445, EP0816449, EP0816448 and EP0816446, the disclosures of each of which are totally incorporated herein by reference, disclose phase change ink compositions suitable for jet printing, which include urethanes as part of the ink vehicle.

Phase change inks used in ink jet printing apparatuses have a number of advantages ranging from vibrant colors and expansive color gamut. It is still desired to produce a phase change ink having a colorant, such as a pigment, substantially evenly dispersed throughout the entire ink vehicle. It is particularly desired to produce phase change inks with at least one pigment that have high stability.

### SUMMARY

In embodiments, disclosed herein is a phase change ink comprising an ink vehicle, at least one colorant, at least one triamide, and at least one bis-urethane.

In further embodiments, disclosed is a method of forming an ink, comprising preparing an ink vehicle in a first container by mixing the ink vehicle at a temperature of from about 90° C. to about 150° C., preparing a pigment dispersion mixture in a second container by mixing at least one dispersant and at least one colorant to form a mixture, introducing the mixture into a twin screw extruder, further extruding the mixture at a temperature of from about 45° C. to about 110° C., melt-mixing and high shear mixing the extruded mixture together with other ink ingredients including the ink vehicle from the first beaker to form an ink. The ink vehicle in the first beaker may further include at least one bis-urethane, and the dispersant in the second beaker may be at least one triamide. In other embodiments, the dispersant in the second beaker comprises at least one bis-urethane, and at least one triamide.

In yet further embodiments, disclosed is an ink jet system, comprising at least one phase change ink having an ink vehicle, at least one colorant, at least one bis-urethane and at least one triamide, and an ink jet device including an ink jet head consisting of one or more channels for the at least one phase change ink, and a supply path that supplies the at least one phase change ink to the one or more channels of the ink jet head from one or more reservoirs containing the at least one phase change ink.

### EMBODIMENTS

The phase change inks include an ink vehicle that is solid at temperatures of about 20° C. to about 27° C., for example room temperature, and specifically are solid at temperatures below about 40° C. However, the inks change phase upon heating, and are in a molten state at jetting temperatures. Thus, the inks have a viscosity of from about 1 to about 40 centipoise (cP), such as from about 5 to about 15 cP or from about 8 to about 12 cP, at an elevated temperature suitable for ink jet printing, such as temperatures of from about 50° C. to about 150° C.

In this regard, the inks herein may be low energy inks. Low energy inks are solid at a temperature below about 40° C. and have a viscosity of from about 5 to about 15 cP at a jetting temperature of from about 50° C. to about 150° C., such as from about 70° C. to about 130° C. or from about 80° C. to about 130° C. The inks jet at lower temperatures, and thus require lower amounts of energy for jetting.

Any suitable ink vehicle can be employed. Suitable vehicles can include paraffins, microcrystalline waxes, polyethylene waxes, ester waxes, fatty acids and other waxy materials, fatty amide containing materials, sulfonamide materials, resinous materials made from different natural sources (tall oil rosins and rosin esters, for example), and many synthetic resins, oligomers, polymers, and copolymers such as further discussed below, and mixtures thereof.

Examples of suitable specific ink vehicles include, for example, ethylene/propylene copolymers, such as those available from Baker Petrolite having the general formula

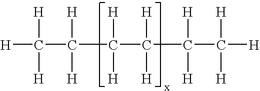

wherein x is an integer of from about 1 to about 200, such as from about 5 to about 150 or from about 12 to about 105. These materials may have a melting point of from about 60° C. to about 150° C., such as from about 70° C. to about 140° C. or from about 80° C. to about 130° C. and a molecular weight (Mn) of from about 100 to about 5,000, such as from about 200 to about 4,000 or from about 400 to about 3,000. Commercial examples of such copolymers include, for example, Petrolite CP-7 (Mn=650), Petrolite CP-11 (Mn=1,100), Petrolite CP-12 (Mn=1,200), and the like. Examples of was ink vehicles include PW400 (Mn about 400), distilled PW400, in one embodiment having a viscosity of about 10% to about 100% higher than the viscosity of the undistilled POLYWAX® 400 at about 110° C., POLYWAX®500 (Mn about 500), distilled POLYWAX® 500, in one embodiment having a viscosity of about 10% to about 100% higher than the viscosity of the undistilled POLYWAX® 500 at about 110° C., POLYWAX 655 (Mn about 655), distilled POLYWAX® 655, in one embodiment having a viscosity of about 10% to about 50% lower than the viscosity of the undistilled POLYWAX® 655 at about 110° C., and in yet another embodiment having a viscosity of about 10% to about 50% higher than the viscosity of the undistilled POLYWAX® 655 at about 110° C., POLYWAX 850 (Mn about 850), POLYWAX 1000 (Mn about 1,000), and the like.

Another type of ink vehicle may be n-paraffinic, branched paraffinic, and/or aromatic hydrocarbons, typically with from about 5 to about 100, such as from about 20 to about 180 or from about 30 to about 60 carbon atoms, generally prepared by the refinement of naturally occurring hydrocarbons, such as BE SQUARE 185 and BE SQUARE 195, with molecular weights (Mn) of from about 100 to about 5,000, such as from about 250 to about 1,000 or from about 500 to about 800, for example such as available from Baker Petrolite.

Highly branched hydrocarbons, typically prepared by olefin polymerization, such as the VYBAR materials available from Baker Petrolite, including VYBAR 253 (Mn=520), VYBAR 5013 (Mn=420), and the like, may also be used. In addition, the ink vehicle may be an ethoxylated alcohol, such as available from Baker Petrolite and of the general formula

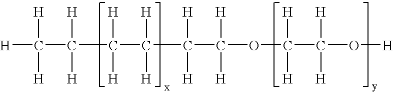

wherein x is an integer of from about 1 to about 50, such as from about 5 to about 40 or from about 11 to about 24 and y is an integer of from about 1 to about 70, such as from about 1 to about 50 or from about 1 to about 40, The materials may have a melting point of from about 60° C. to about 150° C., such as from about 70° C. to about 120° C. or from about 80° C. to about 110° C. and a molecular weight (Mn) range of from about 100 to about 5,000, such as from about 500 to about 3,000 or from about 500 to about 2,500. Commercial examples include UNITHOX 420 (Mn=560), UNITHOX 450 (Mn=900), UNITHOX 480 (Mn=2,250), UNITHOX 520 (Mn=700), UNITHOX 550 (Mn=1,100), UNITHOX 720 (Mn=875), UNITHOX 750 (Mn=1,400), and the like.

As an additional example, mention may be made of fatty amides, such as monoamides, tetra-amides, mixtures thereof, and the like, for example such as described in U.S. Pat. No. 6,858,070, incorporated herein by reference. Suitable monoamides may have a melting point of at least about 50° C., for example from about 50° C. to about 150° C., although the melting point can be below this temperature. Specific examples of suitable monoamides include, for example, primary monoamides and secondary monoamides. Stearamide, such as KEMAMIDE S available from Witco Chemical Company and CRODAMIDE S available from Croda, behenamide/arachidamide, such as KEMAMIDE B available from Witco and CRODAMIDE BR available from Croda, oleamide, such as KEMAMIDE U available from Witco and CRODAMIDE OR available from Croda, technical grade oleamide, such as KEMAMIDE O available from Witco, CRODAMIDE O available from Croda, and UNISLIP 1753 available from Uniqema, and erucamide such as KEMAMIDE E available from Witco and CRODAMIDE ER available from Croda, are some examples of suitable primary amides. Behenyl behenamide, such as KEMAMIDE EX666 available from Witco, stearyl stearamide, such as KEMAMIDE S-180 and KEMAMIDE EX-672 available from Witco, stearyl erucamide, such as KEMAMIDE E-180 available from Witco and CRODAMIDE 212 available from Croda, erucyl erucamide, such as KEMAMIDE E-221 available from Witco, oleyl palmitamide, such as KEMAMIDE P-181 available from Witco and CRODAMIDE 203 available from Croda, and erucyl stearamide, such as KEMAMIDE S-221 available from Witco, are some examples of suitable secondary amides. Additional suitable amide materials include KEMAMIDE W40 (N,N′-ethylenebisstearamide), KEMAMIDE P181 (oleyl palmitamide), KEMAMIDE W45 (N,N′-thylenebisstearamide), and KEMAMIDE W20 (N,N′-ethylenebisoleamide).

High molecular weight linear alcohols, such as those available from Baker Petrolite and of the general formula

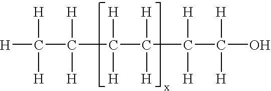

wherein x is an integer of from about 1 to about 50, such as from about 5 to about 35 or from about 11 to about 23, may also be used as the ink vehicle. These materials may have a melting point of from about 50° C. to about 150° C., such as from about 70° C. to about 120° C. or from about 75° C. to about 110° C., and a molecular weight (Mn) range of from about 100 to about 5,000, such as from about 200 to about 2,500 or from about 300 to about 1,500. Commercial examples include the UNILIN materials such as UNILIN 425 (Mn=460), UNILIN 550 (Mn=550), UNILIN 700 (Mn=700), and the like.

Another example includes modified maleic anhydride hydrocarbon adducts of polyolefins prepared by graft copolymerization, such as those available from Baker Petrolite and of the general formulas

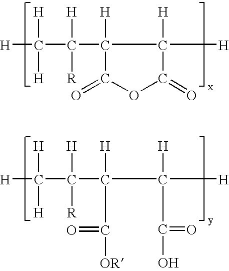

wherein R is an alkyl group with from about 1 to about 50, such as from about 5 to about 35 or from about 6 to about 28 carbon atoms, R′ is an ethyl group, a propyl group, an isopropyl group, a butyl group, an isobutyl group, or an alkyl group with from about 5 to about 500, such as from about 10 to about 300 or from about 20 to about 200 carbon atoms, x is an integer of from about 9 to about 13, and y is an integer of from about 1 to about 50, such as from about 5 to about 25 or from about 9 to about 13, and having melting points of from about 50° C. to about 150° C., such as from about 60° C. to about 120° C. or from about 70° C. to about 100° C.; those available from Baker Petrolite and of the general formula

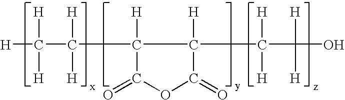

wherein x is an integer of from about 1 to about 50, such as from about 5 to about 25 or from about 9 to about 13, y is 1 or 2, and z is an integer of from about 1 to about 50, such as from about 5 to about 25 or from about 9 to about 13; and those available from Baker Petrolite and of the general formula

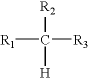

wherein R₁ and R₃ are hydrocarbon groups and R₂ is either of one of the general formulas

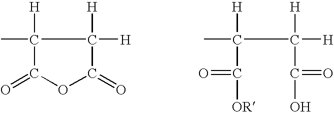

or a mixture thereof, wherein R′ is an isopropyl group, which materials may have melting points of from about 70° C. to about 150° C., such as from about 80° C. to about 130° C. or from about 90° C. to about 125° C., with examples of modified maleic anhydride copolymers including CERAMER 67 (Mn=655, Mw/Mn=1.1), CERAMER 1608 (Mn=700, Mw/Mn=1.7), and the like.

Additional examples of suitable ink vehicles for the phase change inks include rosin esters, such as glyceryl abietate (KE-100®); polyamides; dimer acid amides; fatty acid amides, including ARAMID C; epoxy resins, such as EPOTUF 37001, available form Riechold Chemical Company; fluid paraffin waxes; fluid microcrystalline waxes; Fischer-Tropsch waxes; polyvinyl alcohol resins; polyols; cellulose esters; cellulose ethers; polyvinyl pyridine resins; fatty acids; fatty acid esters; poly sulfonamides, including KETJENFLEX MH and KETJENFLEX MS80; benzoate esters, such as BENZOFLEX S552, available from Velsicol Chemical Company; phthalate plasticizers; critrate placticizers; maleate placticizers; polyvinyl pyrrolidinone copolymers; polyvinyl pyrrolidone/polyvinyl acetate copolymers; novolac resins, such as DUREZ 12 686, available from Occidental Chemical Company; and natural product waxes, such as beeswax, montan wax, candelilla wax, GILSONITE (American Gilsonite Company), and the like; mixtures of linear primary alcohols with linear long chain amides or fatty acid amides, such as those with from about 6 to about 24 carbon atoms, including PARICIN 9 (propylene glycol monohydroxystearate), PARICIN 13 (glycerol monohydroxystearate), PARICIN 15 (ethylene glycol monohydroxystearate), PARICIN 220 (N(2-hydroxyethyl)-12-hydroxystearamide), PARICIN 285 (N,N′-ethylene-bis-12-hydroxystearamide), FLEXRICIN 185 (N,N′-ethylene-bis-ricinoleamide), and the like. Further, linear long chain sulfones with from about 4 to about 16 carbon atoms, such as diphenyl sulfone, n-arnyl sulfone, n-propyl sulfone, n-pentyl sulfone, n-hexyl sulfone, n-heptyl sulfone, n-octyl sulfone, n-nonyl sulfone, n-decyl sulfone, n-undecyl sulfone, n-dodecyl sulfone, n-tridecyl sulfone, n-tetradecyl sulfone, n-pentadecyl sulfone, n-hexadecyl sulfone, chlorophenyl methyl sulfone, and the like, are suitable ink vehicle materials.

In addition, the ink vehicles described in U.S. Pat. No. 6,906,118, incorporated herein by reference in its entirety, may also be used. Also suitable as ink vehicles are liquid crystalline materials as disclosed in, for example, U.S. Pat. No. 5,122,187, the disclosure of which is totally incorporated herein by reference.

The ink vehicle may comprise one or more of the aforementioned suitable vehicles. As used herein, “one or more” and “at least one” refers to, for example, from 1 to about 10, such as from 1 to about 8 or from 1 to about 5, of any given feature disclosed herein.

The ink vehicle may comprise from about 25% to about 99.5% by weight of the ink, for example from about 30% to about 90% or from about 50% to about 85% by weight of the ink.

The ink image discussed herein may be formed from any such suitable phase change ink, for example, those inks disclosed in U.S. Pat. No. 4,490,731, U.S. Pat. No. 5,006,170 and U.S. Pat. No. 5,122,187, the disclosures of which are incorporated herein by reference in their entirety.

Phase change ink jet processes are well known and are described, for example, in U.S. Pat. Nos. 4,601,777, 4,251,824, 4,410,899, 4,412,224 and 4,532,530, the disclosures of which are incorporated herein by reference in their entirety.

The inks disclosed herein may contain any suitable colorant which may include at least one pigment. As used herein the term “colorant” includes pigment, dye, mixtures of dyes, mixtures of pigments, mixtures of dyes and pigments, and the like.

Examples of suitable pigments include, but are not limited to, Violet PALIOGEN Violet 5100 (BASF); PALIOGEN Violet 5890 (BASF); HELIOGEN Green L8730 (BASF); LITHOL Scarlet D3700 (BASF); SUNFAST® Blue 15:4 (Sun Chemical 249-0592); Hostaperm Blue B2G-D (Clariant); Permanent Red P-F7RK; Hostaperm Violet BL (Clariant); LITHOL Scarlet 4440 (BASF); Bon Red C (Dominion Color Company): ORACET Pink RF (Ciba): PALIOGEN Red 3871 K (BASF); SUNFAST® Blue 15:3 (Sun Chemical 249-1284); PALIOGEN Red 3340 (BASF); SUNFAST® Carbazole Violet 23 (Sun Chemical 246-1670); LITHOL Fast Scarlet L4300 (BASF); Sunbrite Yellow 17 (Sun Chemical 275-0023); HELIOGEN Blue L6900, L7020 (BASF); Sunbrite yellow 74 (Sun Chemical 272-0558); SPECTRA PAC® C Orange 16 (Sun Chemical 276-3016); HELIOGEN Blue K6902, K6910 (BASF); SUNFAST® Magenta 122 (Sun Chemical 228-0013): HELIOGEN Blue D6840, D7080 (BASF); Sudan Blue OS (BASF); NEOPEN Blue FF4012 (BASF); PV Fast Blue B2GO1 (Clariant); IRGALITE Blue BCA (Ciba); PALIOGEN Blue 6470 (BASF); Sudan Orange G (Aldrich), Sudan Orange 220 (BASF); PALIOGEN Orange 3040 (BASF); PALIOGEN Yellow 152, 1560 (BASF); LITHOL Fast Yellow 0991 K (BASF); PALIOTOL Yellow 1840 (BASF); NOVOPERM Yellow FGL (Clariant); Lumogne Yellow D0790 (BASF); Suco-Yellow L1250 (BASF); Suco-Yellow D1355 (BASF); Suco Fast Yellow D1 355, D1 351 (BASF); HOSTAPERM Pink E 02 (Clariant); Hansa Brilliant Yellow 5GX03 (Clariant); Permanent Yellow GRL 02 (Clariant); Permanent Rubine L6B 05 (Clariant); FANAL Pink D4830 (BASF); CINQUASIA Magenta (DU PONT), PALIOGEN Black L0084 (BASF); Pigment Black K801 (BASF); and carbon blacks such as SPECIAL BLACK 100, SPECIAL BLACK 250, SPECIAL BLACK 350, FW1, FW2, FW200, FW18, SPECIAL BLACK 4, NIPEX 150, NIPEX 160, NIPEX 180, SPECIAL BLACK 5, SPECIAL BLACK 6, PRINTEX 80, PRINTEX 90, PRINTEX 140, PRINTEX 150T, PRINTEX 200, PRINTEX U, and PRINTEX V (Degussa), MOGUL L, REGAL 400R, REGAL 330, REGAL 350, REGAL 350R, and MONARCH 900 (Cabot Chemical Co.), MA77, MA7, MA8, MA11, MA100, MA100R, MA100S, MA230, MA220, MA200RB, MA14, #2700B, #2650, #2600, #2450B, #2400B, #2350, #2300, #2200B, #1000, #970, #3030B, and #3230B (Mitsubishi), RAVEN 2500 ULTRA, RAVEN 5250, RAVEN 5750, RAVEN 5000, (Columbia Chemical Co.), mixtures thereof and the like.

In embodiments, the colorant/pigments may be from about 0.5 weight percent to about 40 weight percent of the ink, such as from about 1 weight percent to about 8 weight percent or from about 1.5 weight percent to about 6 weight percent of the ink. Colorants suitable for use herein include colorant particles having an average particle size of from about 15 nm to about 200 nm, such as from about 15 nm to about 100 nm or from about 15 nm to about 50 nm.

In embodiments, colorants suitable for use herein may be black, such as carbon black. U.S. Pat. No. 6,878,198, U.S. Pat. No. 6,858,070, EP1535974 and EP1535973, each of which is incorporated herein in its entirety by reference, discloses a phase change ink that demonstrates high stability. However, many phase change inks demonstrate a propensity to weep in the printhead of an inkjet printing apparatus. Thus, as explained above, it is still desired to produce phase change inks having a colorant, such as a pigment, that is dispersed in the ink vehicle, and does not demonstrate any weeping.

Weeping refers to the uncontrolled flow of ink from the nozzles of an ink jet printing apparatus onto the face of the printhead of an ink jet printing apparatus, for example as may occur following the passage of the wiper blade across the nozzles or ink jet heads during a purge cycle. Some of the ramifications of weeping include excessive ink purge volume, color mixing in the jets resulting in poor color reproduction in subsequent prints, and potential jetting reliability/robustness issues.

In pigment-based inks in particular, such as those having carbon black particles, weeping may be observed. There are a few challenges in effectively dispersing pigments in the current phase change ink vehicles. For example, the non-polar components in the ink vehicle may hinder pigment stability in the ink. Typically, dispersants may be used to stabilize the pigment particles in the non-polar ink vehicle, but while some dispersants assist with stability, they do not address weeping.

To enable dispersion of the pigment colorants in the liquid vehicle, the dispersant generally comprises first functional groups that anchor the dispersant to the pigment particles and second functional groups that are compatible with the ink vehicle. The first functional groups can suitably anchor or adsorb to the pigment particle in any suitable manner, such as hydrogen bonding, chemical bonding, acid-base reaction, Van der Waals interactions, and the like. Thus, examples of suitable first functional groups that anchor the dispersant to the pigment particles include such functional groups as esters, amides, carboxylic acids, hydroxyl groups, anhydrides, urethanes, ureas, amines, amides and salt groups such as quaternary ammonium salts, and the like. The first functional groups anchor the dispersant to the colorant particles such that the dispersant is, for example, adsorbed, attached to or grafted to the pigment particle. Likewise, examples of the second functional groups that are compatible with the ink vehicle include groups such as alkyl groups, which can be straight or branched, saturated or unsaturated and the like. These second functional groups are compatible with, in particular, low polarity ink vehicle components.

Dispersants suitable for use herein tat reduce weeping in the ink include a combination of at least one triamide and at least one bis-urethane. By “reducing weeping,” it is meant that the ink including the dispersants disclosed herein demonstrates substantially no weeping. “At least one” as used herein refers to, for example, from 0.5 to about 40 such as from 1 to about 20 or from 1 to about 10 for each of the triamides, and bis-urethanes. In embodiments, the ink may include at least one triamide, and at least one bis-urethane.

Triamides suitable for use herein include linear triamides, which are molecules where all three amide groups are drawn in the same molecular chain or branch. Examples of linear triamides include those triamides having the following formulas:

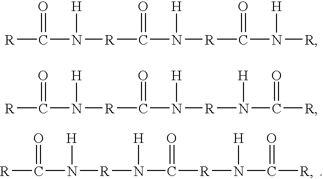

### R can be any hydrocarbon having from about 1 to about 200, carbon atoms, such as from about 25 to 150 carbon atoms or from about 30 to about 100 carbon atoms.

Linear triamides can further include those wherein a line can be drawn through the three amide groups, even if one would ordinarily draw a different line. One example of such a triamide can be expressed by the following formula:

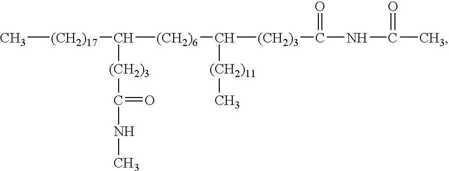

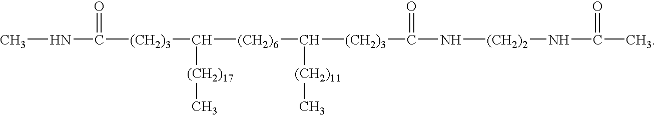

In embodiments, the triamide may also be a branched triamide. Examples of suitable branched triamides include those triamides disclosed in U.S. Pat. No. 6,860,930, which is incorporated herein in its entirety by reference. Any branched triamide disclosed in U.S. Pat. No. 6,860,930, is suitable for use herein. Examples of branched triamides suitable for use herein include those having the formulas:

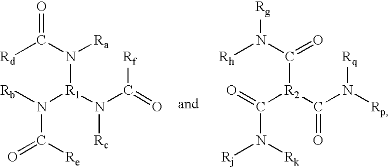

and the like are disclosed in U.S. Pat. No. 6,860,930. In such branched triamides, R₁ and R₂ may be (i) an alkylene group (including linear, branched, saturated, unsaturated, cyclic, substituted, and unsubstituted alkylene groups, and wherein hetero atoms, such as oxygen, nitrogen, sulfur, silicon, phosphorus, and the like either may or may not be present in the alkylene group), having from about 3 carbon atoms to about 200 carbon atoms, such as from about 15 carbon atoms to about 150 carbon atoms or from about 21 carbon atoms to about 100 carbon atoms, although the number of carbon atoms can be outside of these ranges, (ii) an arylene group (including unsubstituted and substituted arylene groups, and wherein hetero atoms, such as oxygen, nitrogen, sulfur, silicon, phosphorus, and the like either may or may not be present in the arylene group), having from about 6 carbon atoms to about 200 carbon atoms, such as from about 10 carbon atoms to about 150 carbon atoms or from about 14 carbon atoms to about 100 carbon atoms, although the number of carbon atoms can be outside of these ranges, (iii) an arylalkylene group (including unsubstituted and substituted arylalkylene groups, wherein the alkyl portion of the arylalkylene group can be linear, branched, saturated, unsaturated, and/or cyclic, and wherein hetero atoms, such as oxygen, nitrogen, sulfur, silicon, phosphorus, and the like either may or may not be present in either or both of the alkyl portion and the aryl portion of the arylalkylene group), having from about 7 carbon atoms to about 200 carbon atoms, such as from about 8 carbon atoms to about 150 carbon atoms or from about 9 carbon atoms to about 100 carbon atoms, although the number of carbon atoms can be outside of these ranges, such as benzylene or the like, or (iv) an alkylarylene group (including unsubstituted and substituted alkylarylene groups, wherein the alkyl portion of the alkylarylene group can be linear, branched, saturated, unsaturated, and/or cyclic, and wherein hetero atoms, such as oxygen, nitrogen, sulfur, silicon, phosphorus, and the like either may or may not be present in either or both of the alkyl portion and the aryl portion of the alkylarylene group), having from about 7 carbon atoms to about 200 carbon atoms, such as from about 8 carbon atoms to about 150 carbon atoms or from about 9 carbon atoms to about 100 carbon atoms, although the number of carbon atoms can be outside of these ranges, such as tolylene or the like. Rₐ, R_{b}, R_{c}, R_{g}, Rₕ, Rⱼ, Rₖ, Rₚ and R_{q} may each independently be (i) a hydrogen atom, (ii) an alkyl group (including linear, branched, saturated, unsaturated, cyclic, substituted, and unsubstituted alkyl groups, and wherein hetero atoms, such as oxygen, nitrogen, sulfur, silicon, phosphorus, and the like either may or may not be present in the alkyl group), in embodiments from about 1 carbon atoms to about 200 carbon atoms, such as from about 6 carbon atoms 150 carbon atoms or from about 10 carbon atoms to about 100 carbon atoms, although the number of carbon atoms can be outside of these ranges, (iii) an aryl group (including unsubstituted and substituted aryl groups, and wherein hetero atoms, such as oxygen, nitrogen, sulfur, silicon, phosphorus, and the like either may or may not be present in the aryl group), having from about 6 carbon atoms to about 200 carbon atoms, such as from about 10 carbon atoms to about 150 carbon atoms or from about 14 carbon atoms to about 100 carbon atoms, although the number of carbon atoms can be outside of these ranges, (iv) an arylalkyl group (including unsubstituted and substituted arylalkyl groups, wherein the alkyl portion of the arylalkyl group can be linear, branched, saturated, unsaturated, and/or cyclic, and wherein hetero atoms, such as oxygen, nitrogen, sulfur, silicon, phosphorus, and the like either may or may not be present in either or both of the alkyl portion and the aryl portion of the arylalkyl group), having from about 6 carbon atoms to about 200 carbon atoms, such as from about 7 carbon atoms to about 150 carbon atoms or from about 8 carbon atoms to about 100 carbon atoms, although the number of carbon atoms can be outside of these ranges, such as benzyl or the like, or (v) an alkylaryl group (including unsubstituted and substituted alkylaryl groups, wherein the alkyl portion of the alkylaryl group can be linear, branched, saturated, unsaturated, and/or cyclic, and wherein hetero atoms, such as oxygen, nitrogen, sulfur, silicon, phosphorus, and the like either may or may not be present in either or both of the alkyl portion and the aryl portion of the alkylaryl group), having from about 6 carbon atoms to about 200 carbon atoms, such as from about 7 carbon atoms to about 150 carbon atoms or from about 8 carbon atoms to about 100 carbon atoms, although the number of carbon atoms can be outside of these ranges, such as tolyl or the like. R_{d}, Rₑ and R_{f} may each independently be (i) an alkyl group as described above, (ii) an aryl group as described above, (iii) an arylalkyl group as described above, or (iv) an alkylaryl group as described above.

The triamide is present in the ink in amounts of from about 0.5 weight percent to about 40 weight percent, such as from about 5 weight percent to about 18 weight percent or from about 8 weight percent to about 13 weight percent of the ink.

Bis-urethanes suitable for use herein include those bis-urethanes having the general formula:

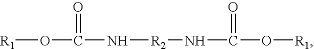

wherein each R₁ may each independently be (i) an alkyl group (including linear, branched saturated, unsaturated, cyclic, substituted, and unsubstituted alkyl groups, and wherein hetero atoms, such as oxygen, nitrogen, sulfur, silicon, phosphorus, and the like either may or may not be present in the alkyl group), in embodiments from about 1 carbon atoms to about 200 carbon atoms, such as from about 6 carbon atoms to about 150 carbon atoms or from about 10 carbon atoms to about 100 carbon atoms, although the number of carbon atoms can be outside of these ranges, (ii) an aryl group (including unsubstituted and substituted aryl groups, and wherein hetero atoms, such as oxygen, nitrogen, sulfur, silicon, phosphorus, and the like either may or may not be present in the aryl group), having from about 6 carbon atoms to about 200 carbon atoms, such as from about 10 carbon atoms to about 150 carbon atoms or from about 14 carbon atoms to about 100 carbon atoms, although the number of carbon atoms can be outside of these ranges, (iii) an arylalkyl group (including unsubstituted and substituted arylalkyl groups, wherein the alkyl portion of the arylalkyl group can be linear, branched, saturated, unsaturated, and/or cyclic, and wherein hetero atoms, such as oxygen, nitrogen, sulfur, silicon, phosphorus, and the like either may or may not be present in either or both of the alkyl portion and the aryl portion of the arylalkyl group), having from about 6 carbon atoms to about 200 carbon atoms, such as from about 7 carbon atoms to about 150 carbon atoms or from about 8 carbon atoms to about 100 carbon atoms, although the number of carbon atoms can be outside of these ranges, such as benzyl or the like, or (iv) an alkylaryl group (including unsubstituted and substituted alkylaryl groups, wherein the alkyl portion of the alkylaryl group can be linear, branched, saturated, unsaturated, and/or cyclic, and wherein hetero atoms, such as oxygen, nitrogen, sulfur, silicon, phosphorus, and the like either may or may not be present in either or both of the alkyl portion and the aryl portion of the alkylaryl group), having from about 6 carbon atoms to about 200 carbon atoms, such as from about 7 carbon atoms to about 150 carbon atoms or from about 8 carbon atoms to about 100 carbon atoms, although the number of carbon atoms can be outside of these ranges, such as tolyl or the like, and R₂ may be (i) an alkylene group (including linear, branched, saturated, unsaturated, cyclic, substituted, and unsubstituted alkylene groups), having from about 3 carbon atoms to about 200 carbon atoms, such as from about 15 carbon atoms to about 150 carbon atoms or from about 21 carbon atoms to about 100 carbon atoms, although the number of carbon atoms can be outside of these ranges, (ii) an arylene group (including unsubstituted and substituted arylene groups), having from about 6 carbon atoms to about 200 carbon atoms, such as from about 10 carbon atoms to about 150 carbon atoms or from about 14 carbon atoms to about 100 carbon atoms, although the number of carbon atoms can be outside of these ranges (iii) an arylalkylene group (including unsubstituted and substituted arylalkylene groups, wherein the alkyl portion of the arylalkylene group can be linear, branched, saturated, unsaturated, and/or cyclic), having from about 7 carbon atoms to about 200 carbon atoms, such as from about 8 carbon atoms to about 150 carbon atoms or from about 9 carbon atoms to about 100 carbon atoms, although the number of carbon atoms can be outside of these ranges, or (iv) an alkylarylene group (including unsubstituted and substituted alkylarylene groups, wherein the alkyl portion of the alkylarylene group can be linear, branched, saturated, unsaturated, and/or cyclic), having from about 7 carbon atoms to about 200 carbon atoms, such as from about 8 carbon atoms to about 150 carbon atoms or from about 9 carbon atoms to about 100 carbon atoms, although the number of carbon atoms can be outside of these ranges.

In embodiments, R₁ is derived from an oxidized petroleum or synthetic wax and R₂ is of the formula:

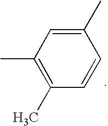

Examples of commercial bis-urethanes suitable for use herein include PETROLITE CA-11®, PETROLITE WB-5® and PETROLITE WB-17®, all available from Baker Petrolite.

The bis-urethane may be present in the ink in amounts of from about 0.5 weight percent to about 40 weight percent, such as from about 1 weight percent to about 8 weight percent or from about 1.5 weight percent to about 5 weight percent of the ink.

Optionally, a propellant may be contained in the phase change ink. Suitable propellants for the phase change ink, present in any effective amount such as from about 10 to about 90 percent by weight, for example from about 20 to about 50 percent by weight, of the ink generally have melting points of from about 50° C. to about 150° C., for example from about 80° C. to about 120° C. In another embodiment, the propellants generally have a boiling point of from about 180° C. to about 250° C., for example from about 200° C. to about 230° C. Further, the surface tension of the propellant in its liquid state at the operating temperature of the ink may be from about 20 to about 65 dynes per centimeter, for example from about 40 to about 65 dynes per centimeter, to enhance refill rates, paper wetting, and color mixing. In addition, the propellants ideally have a viscosity to the operating temperature of the ink of from about 1 to about 20 cP, for example from about 1 to about 15 cP, to enhance refill, jettability, and substrate penetration. The propellant may also be thermally stable in its molten state so that it does not undergo decomposition to yield gaseous products or to form heater deposits.

The ink of embodiments may further include conventional additives to take advantage of the known functionality associated with such conventional additives. Such additives may include, for example, biocides, defoamers, slip and leveling agents, plasticizers, viscosity modifiers, antioxidants, UV absorbers, etc.

Optional biocides may be present in amounts of from about 0.1 to about 1.0 percent by weight of the ink. Suitable biocides include, for example, sorbic acid, 1-(3-chloroallyl)-3,5,7-triaza-1-azoniaadamantane chloride, commercially available as DOWICIL 200 (Dow Chemical Company), vinylene-bis thiocyanate, commercially available as CYTOX 3711 (American Cyanamid Company), disodium ethylenebis-dithiocarbamate, commercially available as DITHONE D14 (Rohm & Haas Company), bis(trichloromethyl)sulfone, commercially available as BIOCIDE N-1386 (Stauffer Chemical Company), zinc pyridinethione, commercially available as zinc omadine (Olin Corporation), 2-bromo-t-nitropropane-1,3-diol, commercially available as ONYXIDE 500 (Onyx Chemical Company), BOSQUAT MB50 (Louza, Inc.), and the like.

Plasticizers may be included in the ink, and may include, for example, pentaerythritol tetrabenzoate, commercially available as BENZOFLEX S552 (Velsicol Chemical Corporation), trimethyl titrate, commercially available as CITROFLEX 1 (Monflex Chemical Company), N,N-dimethyl oleamide, commercially available as HALCOMID M-18-OL (C.P. Hall Company), a benyl phthalate, commercially available as SANTICIZER 278 (Ferro Corporation), and the like, may be added to the ink vehicle, and may constitute from about 1 to 100 percent of the ink vehicle component of the ink. Plasticizers can either function as the ink vehicle or can act as an agent to provide compatibility between the ink propellant, which generally is polar, and the ink vehicle, which generally is non-polar.

The ink may further include an optional viscosity modifier, such as (1) 2-hydroxybenzyl alcohol, (2) 4-hydroxybenzyl alcohol, (3) 4-nitrobenzyl alcohol, (4) 4-hydroxy-3-methoxy benzyl alcohol, (5) 3-methoxy-4-nitrobenzyl alcohol, (6) 2-amino-5-chlorobenzyl alcohol, (7) 2-amino-5-methylbenzyl alcohol, (8) 3-amino-2-methylbenzyl alcohol, (9) 3-amino-4-methyl benzyl alcohol, (10) 2(2-(aminomethyl) phenylthio) benzyl alcohol, (11) 2,4,6-trimethylbenzyl alcohol, (12) 2-amino-2-methyl-1,3-propanediol, (13) 2-amino-1-phenyl-1,3-propanediol, (14) 2,2-dimethyl-1-phenyl-1,3-propanediol, (15) 2-bromo-2-nitro-1,3-propanediol, (16) 3-tert-butylamino-1,2-propanediol, (17) 1,1-diphenyl-1,2-propanediol, (18) 1,4-dibromo-2,3-butanediol, (19) 2,3-dibromo-1,4-butanediol, (20) 2,3-dibromo-2-butene-1,4diol, (21) 1,1,2-triphenyl-1,2-ethanediol, (22) 2-naphthalenemethanol, (23) 2-methoxy-1-naphthalenemethanol, (24) decafluoro benxhydrol, (25) 2-methylbenzhydrol, (26) 1-benzeneethanol, (27) 4,4′-isopropylidene bis(2-(2,6-dibromo phenoxy)ethanol), (28) 2,2′-(1,4-phenylenedioxy)diethanol, (29) 2,2-bis (hydroxymethyl)-2,2′,2″-nitrilotriethanol, (30) di(trimethylolpropane), (31) 2-amino-3-phenyl-1-propanol, (32) trieyelohexylmethanol, (33) tris(hydroxymethyl) aminomethane succinate, (34) 4,4′-trimethylene bis(1-piperidine ethanol), (35) N-methyl glucamine, (36) xylitol, or mixtures thereof. When present, the viscosity modifier is present in the ink in any effective amount, such as from about 30 percent to about 55 percent by weight of the ink or from about 35 percent to about 50 percent by weight of the ink. The ink may optionally contain antioxidants to protect the images from oxidation and also may protect the ink components from oxidation while existing as a heated melt in the ink reservoir. Examples of suitable antioxidants include (1) N,N′-hexamethylene bis(3,5-di-tert-butyl-4-hydroxy hydrocinnamamide) (IRGANOX 1098, available from Ciba-Geigy Corporation), (2) 2,2-bis(4-(2-(3,5-di-tert-butyl-4-hydroxyhydrocinnamoyloxy))ethoxyphenyl) propane (TOPANOL-205, available from ICI America Corporation), (3) tris(4-tert-butyl-3-hydroxy-2,6-dimethyl benzyl) isocyanurate (CYANOX 1790, 41,322-4, LTDP, Aldrich D12,840-6), (4) 2,2′-ethylidene bis(4,6-di-tert-butylphenyl) fluoro phosphonite (ETHANOX-398, available from Ethyl Corporation), (5) tetrakis(2,4-di-tert-butylphenyl)-4,4′-biphenyl diphosphonite (ALDRICH 46,852-5; hardness value 90), (6) pentaerythritol tetrastearate (TCI America #PO739), (7) tributylammonium hypophosphite (Aldrich 42,009-3), (8) 2,6-di-tert-butyl-4-methoxyphenol (Aldrich 25,106-2), (9) 2,4-di-tert-butyl-6-(4-methoxybenzyl) phenol (Aldrich 23,008-1), (10) 4-bromo-2,6-dimethylphenol (Aldrich 34,951-8), (11) 4-bromo-3,5-didimethylphenol (Aldrich B6,420-2), (12) 4-bromo-2-nitrophenol (Aldrich 30,987-7), (13) 4-(diethyl aminomethyl)-2,5-dimethylphenol (Aldrich 14,668-4), (14) 3-dimethylaminophenol (Aldrich D14,400-2), (15) 2-amino-4-tert-amylphenol (Aldrich 41,258-9), (16) 2,6-bis(hydroxymethyl)-p-eresol (Aldrich 22,752-8), (17) 2,2′-methylenediphenol (Aldrich B4,680-8), (18) 5-(diethylamino)-2-nitrosophenol (Aldrich 26,951-4), (19) 2,6-dichloro-4-fluorophenol (Aldrich 28,435-1), (20) 2,6-dibromo fluoro phenol (Aldrich 26,003-7), (21) α-trifluoro-o-creso-1 (Aldrich 21,979-7), (22) 2-bromo-4-fluorophenol (Aldrich 30,246-5), (23) 4-fluorophenol (Aldrich F1,320-7), (24) 4-chlorophenyl-2-chloro1,1,2-tri-fluoroethyl sulfone (Aldrich 13,823-1), (25) 3,4-difluoro phenylacetic acid (Aldrich 29,043-2), (26) 3-fluorophenylacetic acid (Aldrich 24,804-5), (27) 3,5-difluoro phenylacetic acid (Aldrich 29,044-0), (28) 2-fluorophenylacetic acid (Aldrich 20,894-9), (29) 2,5-bis (trifluoromethyl) benzuic acid (Aldrich 32,527-9), (30) ethyl-2-(4-(4-(trifuoromethyl) phenoxy) phenoxy) propionate (Aldrich 25,074-0), (31) tetrakis (2,4-di-tert-butyl phenyl)-4,4′-biphenyl diphosphonite (Aldrich 46,852-5), (32) 4-tert-amyl phenol (Aldrich 15,384-2), (33) 3-(2H-benzotriazol-2-yl)-4-hydroxy phenethylalcohol (Aldrich 43,071-4), NAUGARD 76, NAUGARD 445, NAUGARD 512, AND NAUGARD 524 (manufactured by Uniroyal Chemical Company), and the like, as well as mixtures thereof. The antioxidant, when present, may be present in the ink in any desired or effective amount, such as from about 0.25 percent to about 10 percent by weight of the ink or from about 1 percent to about 5 percent by weight of the ink.

The ink can also optionally contain a UV absorber. The optional UV absorbers prinarily protect the generated images from UV degradatoin. Specific examples of suitable UV absorbers include (1) 2-bromo-2′,4-dimethoxyacetophenone (Aldrich 19,948-6), (2) 2-bromo-2′,5′-dimethoxyacetophenone (Aldrich 10,458-2), (3) 2-bromo-3′-nitroacetophenone (Aldrich 34,421-4), (4) 2-bromo-4′-nitroacetophenone (Aldrich 24,561-5), (5) 3′,5′-diacetoxyacetophenone (Aldrich 11,738-2), (6) 2-phenylsulfonyl acetophenone (Aldrich 34,150-3), (7) 3′-aminoacetophenone (Aldrich 13,935-1), (8) 4′-aminoacetophenone (Aldrich A3,800-2), (9) 1H-benzotriazole-1-acetonitrile (Aldrich 46,752-9), (10) 2-(2H-benzotriazol-2-yl)-4,6-di-tert-pentylphenol (Aldrich 42,274-6), (11) 1,1-(1,2-ethane-diyl)bis(3,3,5,5-tetramethylpiperazinone) (commercially available from Goodrich Chemicals), (12) 2,2,4-trimethyl-1,2-hydroquinoline (commercially available from Mobay Chemical), (13) 2-(4-benzoyl-3-hydroxy phenoxy)ethylacrylate, (14) 2-dodecyl-N-(1,2,2,6,6-pentamethyl-4-piperidinyl) succinimide (commercially available from Aldrich Chemical Co., Milwaukee, Wis.), (15) 2,2,6,6-tetramethyl-4-piperidinyl/β-tetramethyl-3,9-(2,4,8,10-tetraoxo spiro(5,5)-undecane) diethyl-1,2,3,4-butane tetramethyl-3,9-(2,4,8,10-tetraoxo spiro(5,5)-undecane)diethyl-1,2,3,4-butane tetracarboxylate (commercially available from Fairmount), (16) N-(p-ethoxycatbonylphenyl)-N′-ethyl-N′-phenylformadine (commercially available from Givaudan), (17) 6-ethoxy-1,2-dihydro-2,2,4-trimethylquinoline (commercially available from Monsanto Chemicals), (18) 2,4,6-tris-(N-1,4-dimethylpentyl-4-phenylenediamino)-1,3,5-triazine (commercially available from Uniroyal), (19) 2-dodecyl-N-(2,2,6,6-tetrame-thyl-4-piperidinyl) succinimide (commercially available from Aldrich Chemical Co.), (20) N-(1-acetyl-2,2,6,6-tetramethyl-4-piperidinyl)-2-dodecyl succinimide (commercially available from Aldrich Chemical Co.), (21) (1,2,2,6,6-pentamethyl-4-piperidinyl/β-tetramethyl-3,9-(2,4,8,10-terta oxo-spiro-(5,5)undecane)diethyl)-1,2,3,4,-butane tetracarboxylate (commercially available from Fairmount), (22) (2,2,6,6-tetramethyl-4-piperidinyl)-1,2,3,4-butane tetracarboxylate (commercially available from Fairmount), (23) nickel dibutyl dithio carbamate (commercially available as UV-Chek AM-105 from Ferro), (24) 2-amino-2′,5-dichlorobenzophenone (Aldrich 10,515-5), (25) 2′,amino-4′,5′-dimethoxyacetophenone (Aldrich 32,922-3), (26) 2-benzyl-2-(dimethylamino)-4′-morpholino butyrophenone (Aldrich 40,564-7), (27) 4′-benzylozy-2′-hydroxy-3′-methylacetophenone (Aldrich 29,884-0), (28) 4,4′-bis(diethylamino) benzophenone (Aldrich 16,032-6), (29) 5-chloro-2-hydroxy benzophenone (Aldrich C4,470-2), (30) 4′-piperazinoacetophenone (Aldrich 13,646-8), (31) 4′-piperidinoacetophenone (Aldrich 11,972-5), (32) 2-amino-5-chlorobenzophenone (Aldrich A4,556-4), 33) 3,6-bis(2-methyl-2-morpholinopropionyl)-9-octylcarbazole (Aldrich 46,073-7), and the like, as well as mixtures thereof.

When present, the optional additives may each, or in combination, be present in the ink in any desired or effective amount, such as from about 1 percent to about 10 percent by weight of the ink or from about 3 percent to about 5 percent by weight of the ink.

In embodiments, the ink may be prepared by first preparing the ink vehicle in a first container by mixing the components of the ink vehicle at temperatures of from about 90° C. to about 150° C., such as from about 100° C. to about 145° C. or from about 110° C. to about 140° C. In a separate container, the triamide in powder form, the bis-urethane in powder form and the pigment in powder form are all mixed together. The powder mixture may then be introduced into an extruder and the like, for example a twin screw extruder. The contents in the extruder may then be mixed at temperatures of from about 45° C. to about 90° C., such as from about 50° C. to about 85° C. or from about 60° C. to about 80° C. at about 10 RPM to about 200 RPM, such as at about 25 RPM to about 100 RPM or at about 40 RPM to about 65 RPM. The contents may then be extruded and melt-mixed with the ink vehicle in the first container to form an ink. When the contents are melt-mixed, they may also be high shear mixed.

In further embodiments, the ink may be prepared by first preparing the ink vehicle in a first container by mixing the components of the ink vehicle and the bis-urethane at temperatures of from about 90° C. to about 150° C., such as from about 100° C. to about 145° C. or from about 110° C. to about 140° C. In a separate container, the triamide in powder form and the pigment in powder form are all mixed together. The powder mixture may then be introduced into an extruder and the like, for example a twin screw extruder. The contents in the extruder may then be mixed at temperatures of from about 45° C. to about 110° C., such as from about 50° C. to about 85° C. or from about 60° C. to about 80° C. at about 10 RPM to about 200 ROM, such as at about 25 RPM to about 100 RPM or at about 40 RPM to about 65 RPM. The contents may then be extruded and melt-mixed with the ink vehicle in the first container to form an ink. When the contents are melt-mixed, they may also be high shear mixed.

In yet further embodiments, the ink may be prepared as explained above, except that the powder mixture is not introduced into an extruder. In other words, the powder mixture is not extruded prior to melt-mixing with the ink vehicle. As in other embodiments, when the ink contents are melt-mixed, they may also be high shear mixed.

The inks disclosed herein may exhibit Newtonian behavior from about 100° C. to 130° C., such as from about 110° C. to about 120° C., at shear rate of about 10⁻² to about 10⁴ s⁻¹, such as from about 10⁻¹ to about 10³ s⁻¹.

Printed images may be generated with the ink described herein by incorporating the ink into an ink jet device, for example a thermal ink jet device, an acoustic ink jet device or a piezoelectric ink jet device, heating the ink to an ink jet temperature, and concurrently causing droplets of the molten ink to be ejected in a pattern onto a substrate such as paper or transparency material, which can be recognized as an image. The ink is typically included in the at least one reservoir connected by any suitable feeding device to the ejecting channels and orifices of the ink jet head for ejecting the ink. In the jetting procedure, the ink jet head may be heated, by any suitable method, to the jetting temperature of the inks. The phase change inks are thus transformed from the solid state to a molten state for jetting. “At least one” or “one or more” as used to describe components of the ink jet device, such as the ejecting channels, orifices, etc., refers to, for example, from 1 to about 1 million, such as from about 1 to about 40,000 or about 10 to about 20,000 of any such item found in the ink jet device. “At least one” or “one or more” as used to describe other components of the ink jet device such as the ink jet head, reservoir, feeder, etc., refers to, for example, from 1 to about 15, such as from 1 to about 8 or from 1 to about 4 of any such item found in the ink jet device.

The inks can also be employed indirect (offset) printing ink jet applications, wherein when droplets of the melted ink are ejected in an imagewise pattern onto a recording substrate, the recording substrate is an intermediate transfer member and the ink in the imagewise pattern is subsequently transferred from the intermediate transfer member to a final recording substrate, such as paper or transparency.

Embodiments described above will now be further illustrated by way of the following examples.

### EXAMPLES

### Preparation of Pigment Dispersion, Extrudate A:

Triamide resin (triamide described in U.S. Pat. No. 6,860,930, which is incorporated herein by reference in its entirety) was processed through a blender to form a powder. Thereafter, 750.72 g of the powderized triamide resin and 239.7 g of NIPEX 150 carbon black (obtained from Degussa Canada, Burlington, Ontario) were admixed in a LITTLEFORD M5 blender for 30 minutes. Subsequently, the powder mixture was added at a rate of 0.8 lbs/hr to a DAVO counter-rotating twin screw extruder (Model VS 104, from Deutsche Apparate-Vertrieborganisation GmbH & Co, Troisdorf, Germany). The contents in the extruder were then mixed at 70° C. at 50 RPM. The outlet temperature was set at 75° C. The extruded dispersion (Extrudate A) was then melt-mixed with other ink ingredients to form an ink.

### Ink Example 1

Extrudate A (19.70 g) and PETROLITE CA-11 (5.92 g) (a bis-urethane) from Baker Petrolite were weighed in a 250 ml beaker (A). KEMAMIDE S180 from Crompton Corp. (22.79 g) (a stearamide), KE100 resin from Arakawa Chemical Industries Ltd (16.28 g) (a glyceryl abietate), and NAUGARD N445 from Crompton Corp. (0.18 g) (an antioxidant) were weighed in a separate 250 mL beaker (B). Finally, X1197 polyethylene wax available from Baker Petrolite (81.39 g), and a urethane resin as described in Example 4 of U.S. Pat. No. 6,309,453, which is incorporated herein by reference in its entirety, (3.74 g) were weighed in a third 250 mL beaker (C). Beakers A, B, C were placed in a 130° C. oven and heated for approximately three hours. After two hours of heating, the components in beaker B were stirred with a heated spatula to aid in melting and dissolving the mixture. This stirring with a heated spatula was repeated 30 minutes later. Once the mixture in beaker B was fully dissolved and melted, the contents in beaker B were poured into beaker A.

A Sonic Dismembrator Model 500 Sonifier was then used to sonify the ingredients in beaker A. The sonifier was programmed to sonify the ink for 30 seconds and then pause for 30 seconds, and to repeat this process five times, thus producing a total sonification process time of three minutes. While sonifying, the beaker was rotated to ensure even processing throughout the mixture with the temperature maintained below 130° C. After the first three minute sonification process was complete on beaker A, the beaker was placed back into a 110° C. oven for 30 minutes. Subsequently, the same sonification process was repeated on the contents in beaker A. Thereafter, the contents in beaker C were gradually poured into beaker A throughout the first 30 second sonification interval of the third sonification process carried out on beaker A. The carbon black ink thus prepared exhibited a viscosity of 10.8 cps as measured on an AR2000 rheometer from TA Instruments.

The ink was then filtered subsequently through a 1 μm and then a 0.45 μm glass fiber disc filter at 110° C. with an applied pressure of 15 psi. The final ink was then cooled to room temperature, approximately 25° C., and tested on a piezo ink jet printer for weeping.

### Ink Example 2

A carbon black ink was prepared as in Ink Example 1 except that WB-5, a bis-urethane available from Baker Petrolite, was used in place of PETROLITE CA-11. The composition of this ink is shown in Table 1 below.

### Ink Example 3

A carbon black ink was prepared as in ink example 1 except that WB-17, a bis-urethane available from Baker Petrolite, was used in place of PETROLITE CA-11. The composition of this ink is shown in Table 1 below.

### Ink Example 4

A carbon black ink was prepared as in ink example 1 except that instead of Extrudate A, the triamide resin and the NIPEX 150 carbon black were added to beaker A in powder form, and WB-17 was used in place of PETROLITE CA-11. The composition of this ink is shown in Table 1 below.

### Ink Example 5

A carbon black ink was prepared as in ink example 1 except that no Extrudate A was added, and triamide resin was not added. The NIPEX 150 carbon black was added to beaker A in powder form along with WB-17, which was used in place of PETROLITE CA-11. The composition of this ink is shown in Table 1 below

TABLE 1
Ink Compositions

| | | | | Ink | Ink |
|---|---|---|---|---|---|
| Components | Ink | Ink | Ink | Exam- | Exam- |
| (wt %) | Example 1 | Example 2 | Example 3 | ple 4 | ple 5 |
| Triamide | 10.12 | 10.30 | 10.26 | 10.26 | 0 |
| NIPEX 150 | 3.01 | 3.06 | 3.05 | 3.05 | 3.05 |
| PETROLITE | 3.95 | 0.00 | 0.00 | 0.00 | 0.00 |
| CA-11 | | | | | |
| WB-5 | 0.00 | 2.64 | 0.00 | 0.00 | 0.00 |
| WB-17 | 0.00 | 0.00 | 2.63 | 2.63 | 12.90 |
| Stearyl | 15.19 | 1.25 | 15.40 | 15.40 | 15.40 |
| Stearimide | | | | | |
| Glyceryl Abietate | 10.85 | 10.89 | 11.00 | 11.00 | 11.00 |
| NAUGARD 445 | 0.12 | 0.12 | 0.12 | 0.12 | 0.12 |
| Distilled | 54.26 | 55.20 | 55.00 | 55.00 | 55.00 |
| Polyethylene Wax | | | | | |
| Urethane Resin | 2.50 | 2.54 | 2.53 | 2.53 | 2.53 |
| TOTAL | 100.00 | 100.00 | 100.00 | 100.00 | 100.00 |
| Pigment | Extrudate | Extrudate | Extrudate | Powder | Powder |
| Dispersion | | | | | |
| Viscosity after | 10.76 | 10.45 | 10.68 | 10.78 | 10.77 |
| Filtration | | | | | |
| (110° C.) | | | | | |

The inks were printed on the Xerox PHASER® 8400 printers. When Ink Examples 1 and 2 were printed, no ink was observed on the face of the printhead indicating no weeping. Ink Examples 3, 4 and 5 were tested using two purge cycles, and weeping was tested by counting the number of contaminated jets on each print on paper. Table 2 shows the weeping results of Ink Examples 3, 4 and 5 for the first three pages.

TABLE 2
Printing results

Number of
Contaminated
Ink Jets

| Ink Example No. | Page No. | Purge 1 | Purge 2 |
|---|---|---|---|
| 3 | 1 | 6 | 6 |
| | 2 | 1 | 0 |
| | 3 | 0 | 0 |
| 4 | 1 | 12 | 19 |
| | 2 | 6 | 7 |
| | 3 | 6 | 6 |
| 5 | 1 | 72 | 64 |
| | 2 | 37 | 31 |
| | 3 | 27 | 20 |

In Table 2, the “Page #” refers to the three pages printed upon, in order of their printing. The “Purge 1” and “Purge 2” refer to replicate purge cycles which are performed to clear air from the print head upon startup or to clear weak or missing jets which may develop during normal operation.

Ink Example 3 included both the triamide and WB-17, a bis-urethane, and was prepared using the extrusion method. This ink produced no contaminated jets on the third print page indicating substantially no weeping

Ink Example 4 also included the triamide and WB-17, a bis-urethane. However, the ink was not prepared using the extrusion method. Instead, the triamide and the pigment were used in powder form. This ink produced some contaminated jets on the third print page indicating minor weeping compared to Ink Example 3.

Ink Example 5 was the comparative ink, which only included the WB-17, a bis-urethane, and no triamide. The pigment was added in powder form, as in Ink Example 4. This ink had the highest number of contaminated jets on the third print page indicating significant weeping compared to Ink Examples 3 and 4.

These results indicated that to fully disperse the carbon black pigment in the ink, both the triamide and the WB-17 were required. Also inks prepared by the extrusion method provided a more stable ink.

It will be appreciated that various of the above-disclosed and other features and functions, or alternatives thereof, may be desirably combined into many other different systems or applications, variations or improvements therein may be unanticipated alternatives, modifications, variations or improvements therein may be subsequently made by those skilled in the art, and are also intended to be encompassed by the following claims.

What is claimed is:

1. A phase change ink comprising an ink vehicle, at least one colorant, at least one triamide and at least one bis-urethane.

2. The phase change ink according to claim 1, wherein the colorant is a pigment.

3. The phase change ink according to claim 1, wherein the colorant is carbon black.

4. The phase change ink according to claim 1, wherein the triamide is a branched triamide.

5. The phase change ink according to claim 4, wherein the branched triamide has a formula of: 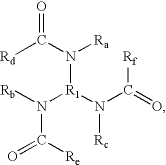
wherein R₁ is (i) an alkylene group having from about 3 carbon atoms to about 200 carbon atoms, (ii) an arylene group having from about 6 carbon atoms to about 200 carbon atoms, (iii) an arylalkylene group having from about 7 carbon atoms to about 200 carbon atoms, or (iv) an alkylarylene group having from about 7 carbon atoms to about 200 carbon atoms, Rₐ, R_{b} and R_{c} are each independently (i) a hydrogen atom, (ii) an alkyl group having from about 1 carbon atoms to about 200 carbon atoms, (iii) an aryl group having from about 6 carbon atoms to about 200 carbon atoms, (iv) an arylalkyl group having from about 6 carbon atoms to about 200 carbon atoms, or (v) an alkylaryl group having from about 6 carbon atoms to about 200 carbon atoms, and R_{d}, Rₑ and R_{f} are each independently (i) an alkyl group having from about 1 carbon atoms to about 200 carbon atoms, (ii) an aryl group having from about 6 carbon atoms to about 200 carbon atoms, (iii) an arylalkyl group having from about 6 carbon atoms to about 200 carbon atoms, or (iv) an alkylaryl group having from about 6 carbon atoms to about 200 carbon atoms.

6. The phase change ink according to claim 4, wherein the branched triamide has a formula of: 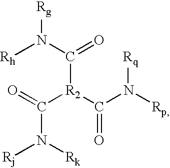
wherein R₂ is (i) an alkylene group having from about 3 carbon atoms to about 200 carbon atoms, (ii) an arylene group having from about 6 carbon atoms to about 200 carbon atoms, (iii) an arylalkylene group having from about 7 carbon atoms to about 200 carbon atoms, or (iv) and alkylarylene group having from about 7 carbon atoms to about 200 carbon atoms and R_{g}, Rₕ, Rⱼ, Rₖ, Rₚ and R_{q} are each independently (i) a hydrogen atom, (ii) an alkyl group having from about 1 carbon atoms to about 200 carbon atoms, (iii) an aryl group having from about 6 carbon atoms to about 200 carbon atoms, (iv) an arylalkyl group having from about 6 carbon atoms to about 200 carbon atoms, or (v) an alkylaryl group having from about 6 carbon atoms to about 200 carbon atoms.

7. The phase change ink according to claim 1, wherein the bis-urethane has a general formula of: 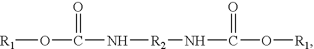
wherein each R₁ is independent of each other (i) an alkyl group having from about 1 carbon atoms to about 200 carbon atoms, (ii) an aryl group having from about 6 carbon atoms to about 200 carbon atoms, (iii) an arylalkyl group having from about 6 carbon atoms to about 200 carbon atoms, or (iv) an alkylaryl group having from about 6 carbon atoms to about 200 carbon atoms, and R₂ is (i) an alkylene group having from about 3 carbon atoms to about 200 carbon atoms, (ii) an arylene group having from about 6 carbon atoms to about 200 carbon atoms, (iii) an arylalkylene group having from about 7 carbon atoms to about 200 carbon atoms, or (iv) an alkylarylene group having from about 7 carbon atoms to about 200 carbon atoms.

8. The phase change ink according to claim 7, wherein R₁ is derived from an oxidized petroleum or a synthetic wax and R₂ is of the formula:

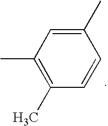

9. The phase change ink according to claim 1, wherein the triamide is present in the ink in amounts of from about 0.5 weight percent to about 40 weight percent, and the bis-urethane is present in the ink in amounts of from about 0.5 weight percent to about 40 weight percent.

10. An ink jet printhead that exhibits substantially no weeping, wherein the ink jet printhead jets the phase change ink according to claim 1.

11. An ink jet system, comprising:
at least one phase change ink having an ink vehicle, at least one colorant, at least one dispersant and at least one bis-urethane, and
an ink jet device including an ink jet head.

12. The ink jet system according to claim 11, wherein the ink jet head further includes one or more channels for the at least one phase change ink, and a supply path that supplies the at least one phase change ink to the one or more channels of the ink jet head from one or more reservoirs containing the at least one phase change ink.

13. The ink jet system according to claim 12, wherein other phase change inks of other colors are separately supplied to the ink jet head.

14. The ink jet system according to claim 11, wherein the at least one phase change ink exhibits substantially no weeping upon jetting through the ink jet head.

15. A method of forming an ink, comprising:
an extrusion step and a melt-mixing step,
the extrusion step comprising preparing a pigment dispersion mixture in a container by mixing at least one triamide, at least one bis-urethane and at least one colorant to form a mixture, introducing the mixture into an extruder, and extruding the mixture,
the melt-mixing step comprising melt-mixing the extruded mixture together with other ink ingredients including an ink vehicle to form the ink.

16. The method according to claim 15, wherein melt-mixing step further comprises high shear mixing.

17. The method according to claim 15, wherein the colorant is a pigment.

18. The method according to claim 15, wherein the colorant is carbon black.

19. The method according to claim 15, wherein the triamide is a branched triamide.

20. The method according to claim 19, wherein the branched triamide has a formula of: 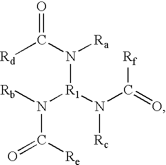
wherein R₁ is (i) an alkylene group having from about 3 carbon atoms to about 200 carbon atoms, (ii) an arylene group having from about 6 carbon atoms to about 200 carbon atoms, (iii) an arylalkylene group having from about 7 carbon atoms to about 200 carbon atoms, or (iv) an alkylarylene group having from about 7 carbon atoms to about 200 carbon atoms, Rₐ, R_{b} and R_{c} are each independently (i) a hydrogen atom, (ii) an alkyl group having from about 1 carbon atoms to about 200 carbon atoms, (iii) an aryl group having from about 6 carbon atoms to about 200 carbon atoms, (iv) an arylalkyl group having from about 6 carbon atoms to about 200 carbon atoms, or (v) an alkylaryl group having from about 6 carbon atoms to about 200 carbon atoms, and R_{d}, Rₑ and R_{f} are each independently (i) an alkyl group having from about 1 carbon atoms to about 200 carbon atoms, (ii) an aryl group having from about 6 carbon atoms to about 200 carbon atoms, (iii) an arylalkyl group having from about 6 carbon atoms to about 200 carbon atoms, or (iv) an alkylaryl group having from about 6 carbon atoms to about 200 carbon atoms.

21. The method according to claim 18, wherein the branched triamide has a formula of: 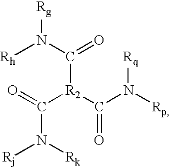
wherein R₂ is (i) an alkylene group having from about 3 carbon atoms to about 200 carbon atoms, (ii) an arylene group having from about 6 carbon atoms to about 200 carbon atoms, (iii) an arylalkylene group having from about 7 carbon atoms to about 200 carbon atoms, or (iv) an alkylarylene group having from about 7 carbon atoms to about 200 carbon atoms and R_{g}, Rₕ, Rⱼ, Rₖ, Rₚ and R_{q} are each independently (i) a hydrogen atom, (ii) an alkyl group having from about 1 carbon atoms to about 200 carbon atoms, (iii) an aryl group having from about 6 carbon atoms to about 200 carbon atoms, (iv) an arylalkyl group having from about 6 carbon atoms to about 200 carbon atoms, or (v) an alkylaryl group having from about 6 carbon atoms to about 200 carbon atoms.

22. The method according to claim 15, wherein the bis-urethane has a general formula of: 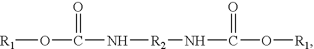
wherein each R₁ is independent of each other (i) an alkyl group having from about 1 carbon atoms to about 200 carbon atoms, (ii) an aryl group having from about 6 carbon atoms to about 200 carbon atoms, (iii) an arylalkyl group having from about 6 carbon atoms to about 200 carbon atoms, or (iv) an alkylaryl group having from about 6 carbon atoms to about 200 carbon atoms, and R₂ is (i) an alkylene group having from about 3 carbon atoms to about 200 carbon atoms, (ii) an arylene group having from about 6 carbon atoms to about 200 carbon atoms, (iii) an arylalkylene group having from about 7 carbon atoms to about 200 carbon atoms, or (iv) an alkylarylene group having from about 7 carbon atoms to about 200 carbon atoms.

23. The method according to claim 15, wherein the triamide is present in the ink in amounts of from about 0.5 weight percent to about 40 weight percent, the bis-urethane is present in the ink in amounts of from about 0.5 weight percent to about 40 weight percent.
